(19) United States
(12) Patent Application Publication
(10) Pub. No.: US 2015/0365760 A1
(43) Pub. Date: Dec. 17, 2015

(54) Rechargeable Hearing Protector Having Multi-function Noise Cancellation Earphone

(71) Applicant: Deyin Jiang, Newport Beach, CA (US)

(72) Inventor: Deyin Jiang, Newport Beach, CA (US)

(21) Appl. No.: 14/303,500

(22) Filed: Jun. 12, 2014

(51) Int. Cl. H04R 3/00; H04R 1/10

(52) U.S. Cl. CPC H04R 3/002; H04R 1/1083

(57) ABSTRACT

Disclosed is a multi-function, rechargeable noise cancellation earphone or hearing protector having AM/FM radio, Bluetooth and MP-3 audio player.

### FIELD OF THE INVENTION

The present invention is related to a rechargeable hearing protector having a multi-function noise cancellation earphone, comprising a frame, an antenna and speaker(s) or microphone. The rechargeable hearing protector is optionally equipped with a digital AM/FM stereo radio, Bluetooth, and/or MP3 player, and other hearing functions.

### BACKGROUND OF THE INVENTION

Current noise cancellation products or ear defender cups usually do not include Bluetooth or MP-3 audio player, which can limit their functionality. Also, current products commonly use non-rechargeable batteries that increase the long-term operation cost and are less environmentally friendly.

Nordin et al. in U.S. Pat. No. 5,384,857, entire contents of which are incorporated herein by reference, discloses a snap-in attachment of a headband or other support means for a hearing-protection cup. The snap-in contact comprises a sliding pin, the journal section of which is oval or elliptical in cross section, and a jaw element with two resiliently deformable jaws. The inner walls of the jaws and the wall section connecting them define a locking space. Nordin et al. further discloses that the sliding pins include an axis of rotation and a journal section of non-circular cross-section taken in a plane perpendicular to the axis of rotation, with the cross-section having double mirror-image symmetry.

It is disclosed herein a rechargeable multi-functional hearing protector having optionally equipped with a digital AM/FM stereo radio, a Bluetooth, an MP3 player, a remotely connectable jack, and other hearing/protection functions.

### SUMMARY OF THE INVENTION

It is one object of the present invention to provide a rechargeable hearing protector having a digital AM/FM stereo radio, a Bluetooth setup for an earphone, speaker(s), an MP3 player and other hearing functions. The hearing protector also serves as ear defender cup when worn on one ear or on both ears with two defender cups. The two ear defender cups on the hearing protector may be optionally symmetrical to fit the ears of a user.

Some aspects of the invention provide the speaker cases of the hearing protector that are featured with an antenna, LCD screen, volume button, settings button, on/off button, aux in, function button, encoder, earmuffs, retractable frame, and the same. Circuit boards and speakers are optionally enclosed in the cases. In one embodiment, the speakers are hidden or enclosed in the case, whereas the speakers or optionally microphone are not visually seen from outside of the hearing protector. The circuit board may include an FM module, Bluetooth module, controller, amplifier module and the same. In one embodiment, the power module is optionally connected with an LCD, AM/FM radio, Bluetooth, controller, amplifier modules, and the same. In another embodiment, the antenna is connected with a controller and AM/FM radio, and the controller is optionally connected with an AM/FM radio and Bluetooth through the encoder. Some aspects of the invention provide the earphone for the rechargeable hearing protector of the present invention that features multiple functions including, but not limited to, an AM/FM radio, Bluetooth and MP-3 audio player in a compact design. It may also include a jack or a rechargeable battery, enabling cordless or corded use.

In summary, the hearing protector of the present invention has digital AM/FM stereo radio, Bluetooth, and MP3 player that is powered by a rechargeable lithium battery or the same. It is specifically designed to protect a user's hearing when working under noisy conditions and create a suitable working atmosphere by listening to the radio, MP3 music, or wireless phone communication.

The radio, Bluetooth, and MP3 player functions with noise cancellation capability provide fascinating performance even in noisy environments. Some aspects of the invention provide a hearing protector having desired sound or songs with noise cancellation capability and/or little noise interference.

### BRIEF DESCRIPTION OF THE DRAWINGS

Additional objects and features of the present invention will become more apparent and the disclosure itself will be best understood from the following Detailed Description of the Exemplary Embodiments, when read with reference to the accompanying drawings.

FIG. 1 shows an exterior appearance of the present invention.

FIG. 2 shows product circuit board design and description of the present invention.

FIG. 3 shows product exterior design and description of the present invention.

### DETAILED DESCRIPTION OF THE EXEMPLARY EMBODIMENTS

The preferred embodiments of the present invention described below relate particularly to a multi-function noise cancellation earphone, also referred herein as multi-function hearing protector, which has a rechargeable power source aspect. The hearing protector may include a frame, antenna, speaker or speakers, and other functions. The speaker cases may be featured with an antenna, LCD screen, volume button, settings button, on/off button, aux in, function button, encoder, earmuffs, retractable frame, and the like. In one embodiment, circuit board(s) and/or speakers are enclosed in the cases of the hearing protector. The circuit board may include an FM module, Bluetooth module, controller, amplifier module, and others. In one embodiment, the power module is connected with an LCD, AM/FM radio, Bluetooth, controller, amplifier modules, whereas the antenna is optionally connected with a controller and FM radio, Furthermore, the controller is optionally connected with an AM/FM radio and Bluetooth through the encoder.

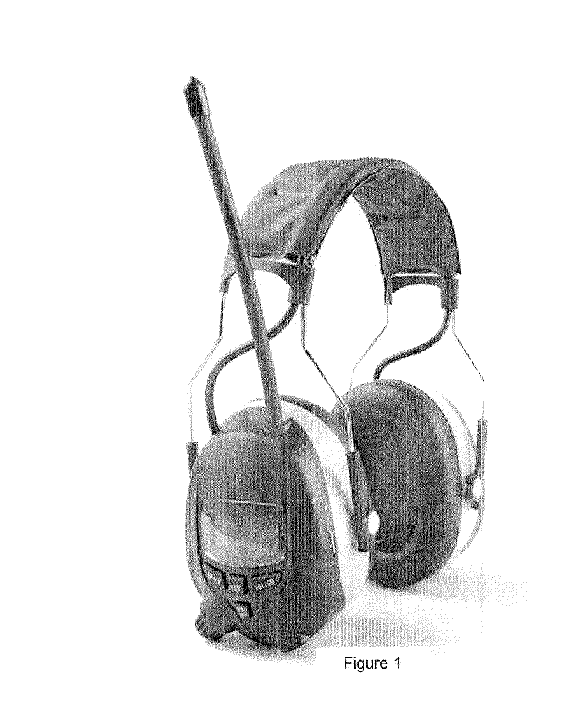

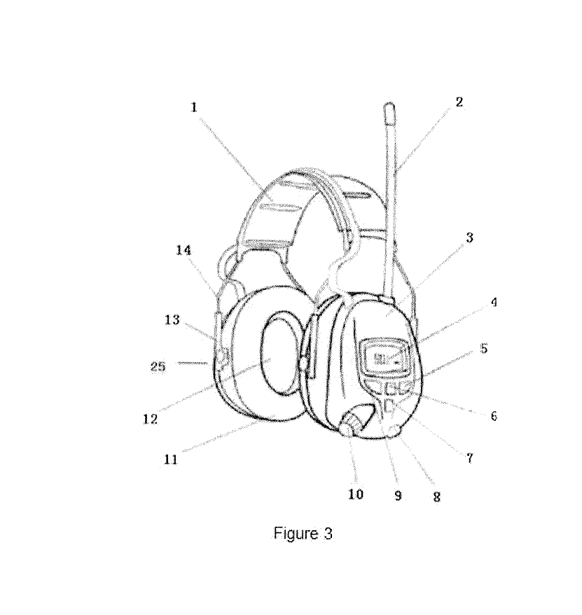

FIG. 1 shows an exterior aspect of the present invention, whereas FIG. 3 shows a product exterior design and description of the present invention. The present invention relates to an earphone frame (1) or other support means for earphone cases (3) or the like which, when in place, are pivotable in relation to the earphone frame. In one embodiment, the earphone case may resemble an ear defender cup having an earmuff (11) or a circular rim that intimately contacts the outer skin surface of the face or cheek for noise containment. In another embodiment, the earmuff provides a noise-proof space from the surrounding environment.

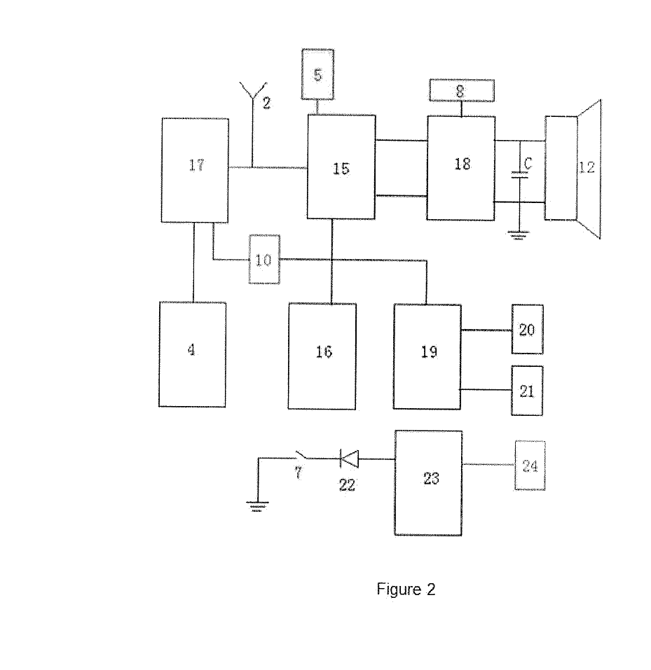

FIG. 2 shows product circuit board design and description of the present invention, including the circuit board and speaker (12).

In one embodiment, the earphone frame (1) may be adjustably connected to the earphone case (3) through a pair of retractable connecting frame elements (13), having support from a mounting hardware (14) for the retractable frame, which connects the earphone frame and the earphone case.

The term hearing protector in this application relates to hearing-protection means for suppressing noise, particularly noise cancellation during work, comprising (a) two noise-suppressing earphone cases (3) designed to cover the ears noise-proof thereby enclosing them in the cases and excluding undesired noise, and (b) means for securing the cases against the ears, such as an earphone frame (1) or the like. The cups may be provided with additional equipment or attachment such as an antenna (2). In one embodiment, the earphone may include a cellphone, a mobile phone, or the like.

In one embodiment as disclosed in FIGS. 2 and 3, the hearing protector also includes an MP-3 audio player (19) with optionally a memory card slot (20) for inserting a memory card and a USB port (21). The hearing protector is connected with the controller (17) through an encoder (10). In one embodiment, the controller is optionally connected with the encoder (10), an AM/FM module (15), a Bluetooth module (16), and/or the MP-3 audio player (19).

In another embodiment, the power module includes an on/off button (7), a volume button (5), a function button (9), a settings button (6), a power inlet (24), battery (23) or batteries that is optionally connected with an LCD monitor (4), the AM/FM module (15), the Bluetooth module (16), the controller (17), an amplifier (18), the MP-3 audio player (19) and a power indicator (22). In one embodiment, the power indicator or power indication is connected with the MP-3 audio player as shown in FIG. 2. In still another embodiment, this product features a rechargeable battery, preferably a Lithium-ion type battery. In one embodiment, this product features an LCD screen (4).

As illustrated in FIGS. 1, 2, and 3, the Bluetooth module of the hearing protector of the present invention includes a headset (25) and music functions, which are characterized via Hand Free Profile (HFP) and Head Set Profile (HSP) as defined herein below. The HFP includes redial, refuse and incoming call hold functions, and preferably adopts a single channel speaker design. The HSP features a stereo design for music playback. The Bluetooth module (16) in this product includes both functionalities and is activated by long press the power button (7) until the LCD screen (4) displays “bton”. It can be turned off by long press the power button (7) again.

The Bluetooth module can be paired with cellphone(s). After turning on the earphone by pressing the power button (7), press the function button (9), and chose “BT” to activate Bluetooth music playback.

The AM/FM radio module (15) consists of an integrated radio module and an LCD decoder. The radio signals are received by the antenna (2). The radio module amplifies the radio signals and applies a built-in AGC (Automatic Frequency Control) to convert the analogue signals into digital signals. Through controls interface including the encoder (10) and the volume button (5); the module converts digital signals back to analogue signals and then pass through the amplifier (18), finally outputs the audio through the speakers (12). The LCD decoder processes the radio frequency and displays it on the LCD monitor screen (4).

The MP-3 audio player (19) adopts a high compress ratio technology (a ratio of 12:1 or more). Without compromising audio quality, the size for each minute's audio is only about 1 MB. The MP3 module decodes the files and outputs the audio through the speakers (12).

It is very easy for music lovers to download music from the internet and save it in memory card (not shown). Simply plug in the memory card into the slot (20) or connect the earphone with a computer using the USB port (19).

In one embodiment, the encoder (10) can be used to control the AM/FM module (15), MP-3 audio player (19), and/or the Bluetooth module (16).

The power module includes the power inlet (24), battery or batteries, power indication (22), and on/off button (7). The battery can be charged from power inlet (24), the earphone also accepts corded use through the inlet (24). The hearing protector of the present invention is optionally equipped with a rechargeable battery system.

Special features of the present invention comprise at least two aspects: First, the circuits are highly integrated, which consists of 4 or more PCB (such as AM/FM, MP-3, Bluetooth, LCD decoder, and the like). This feature significantly increases the efficiency and reduces the size via minimizing the bulkiness. Second, the digital process helps reduce the noise and non-linear distortion, which increases or enhances the audio quality.

In a further embodiment, the hearing protector of the present invention comprises a water-proof DC jack, which is capable of connecting to an MP3 cable, PTT cable, walkie-talkie cable, or the like for long distance connecting (either wired, partially wired, or wireless) use. In one embodiment, the hearing protector with a connecting jack is capable of enabling a high power walkie-talkie, wireless computer, CD, radio, or other mobile phones from a distance of 35 miles or longer.

In use, one may snugly fit the earmuffs (11) on the ears, and press the power button (7). If one wishes to listen to an FM radio, press the function button (9). Then use the encoder to fine tune the frequency from 87.5-108 MHz until a clear signal is received. In one embodiment, one may turn the encoder (10) while pressing the volume button (5) to change the volume.

To receive AM signals, one may press the AM/FM button (9) until the LCD displays 522-1710 KHz, use the encoder (10) to fine tune the frequency. Further, to use the aux function, one may plug in the male aux cable into the aux in (8) of the hearing protector.

The earphone optionally features a retractable frame design. While not in use, one may push the earphone cases (3) up into the frame to reduce the size for storage and transportation.

The earmuff (11) can be easily disassembled for cleaning, storage, or the like.

In one embodiment of the present invention, the ear cushions are soft to provide good comfortable seal. Cushions are also removable and washable. In one embodiment, the rechargeable hearing protector of the present invention provides AM, FM, MP3 and Bluetooth options. It is easy to access the control knob for ideal volume control.

In one embodiment of the present invention, the built-in antenna has high reception sensitivity. It is also able to preset channels and utilize memory functions (8 different channels or more). The rechargeable hearing protector of the present invention has frequency scanning and automatic search function; frequency may range from 87.5-108 MHz in FM and 520-1710 KHz in AM.

For the battery portion, the rechargeable hearing protector has a function of clearly displaying low battery, timing, and frequency, whereas the lithium battery may be charged via a USB cable or replaced.

Some aspects of the invention relate to a hearing protector comprising a noise-cancellation earphone and a rechargeable power unit for providing power to the earphone.

Some aspects of the invention relate to a hearing protector having a noise-cancellation earphone, wherein the earphone comprises an earphone frame, an earphone case, and optionally other auxiliary attachments.

Some aspects of the invention relate to a hearing protector having a noise-cancellation earphone and an earphone case connected to the earphone through an earphone frame, wherein the earphone case is connected to the earphone frame through a retractable connecting frame element having a mounting hardware for the retractable frame.

Some aspects of the invention relate to a hearing protector having a noise-cancellation earphone, wherein the earphone further comprises a comfortable touch pad for placing on one cheek of a user's face, wherein the touch pad is on an opposite side of the earphone case and the touch pad is connected to the earphone frame through a second retractable connecting frame element having a second mounting hardware for the second retractable frame. This touch pad feature is preferred for placing the touch pad on the cheek of the user, possibly with one deaf ear.

Some aspects of the invention relate to a hearing protector having a noise-cancellation earphone and an earphone case connected to the earphone through an earphone frame, wherein the earphone case is connected with one component selected from the group consisting of an antenna, LCD screen, volume button, settings button, on/off button, aux in, function button, encoder, earmuffs, and retractable frame.

Some aspects of the invention relate to a hearing protector having a noise-cancellation earphone and an earphone case connected to the earphone through an earphone frame, wherein the earphone case is connected with an antenna and wherein the antenna is connected with a controller and an FM radio. In one embodiment, the controller is connected with an AM/FM radio and Bluetooth through the encoder. In another embodiment, an MP-3 audio player with a memory card slot and a USB port is connected with the controller through the encoder.

Some aspects of the invention relate to a hearing protector having a noise-cancellation earphone and an earphone case connected to the earphone through an earphone frame, wherein the earphone case further comprises at least one circuit board and/or at least one speaker and/or microphone. In one embodiment, the circuit board comprises one component selected from the group consisting of an FM module, Bluetooth module, controller, and amplifier module. In another embodiment, the at least one speaker and/or microphone is enclosed in the earphone case. The capability of enclosing the microphone is for ease of transportation with less accidental or careless damage.

Some aspects of the invention relate to a hearing protector having a noise-cancellation earphone and an earphone case connected to the earphone through an earphone frame, wherein the earphone case further comprises a power module that is connected with one component selected from the group consisting of an LCD, AM/FM radio, Bluetooth, controller, and amplifier modules. In one embodiment, the power module comprises a power inlet, battery, power indication and on/off button.

Some aspects of the invention relate to a hearing protector having a rechargeable power unit for providing power to the earphone. In one embodiment, the rechargeable power unit is a rechargeable Lithium-ion battery. The advantages of the rechargeability for using the Lithium-ion battery is for cost containment and environmental protection rather than using a non-rechargeable battery in the conventional device, hearing protection, or the earphone.

Although the present invention has been described with reference to specific details of certain embodiments thereof, it is not intended that such details should be regarded as limitations upon the scope of the invention except as and to the extent that they are included in the accompanying claims. Many modifications and variations are possible in light of the above disclosure.

What is claimed is:

1. A hearing protector comprising a noise-cancellation earphone and a rechargeable power unit for providing power to said earphone.

2. The hearing protector of claim 1, wherein the earphone comprises an earphone frame and an earphone case.

3. The hearing protector of claim 2, wherein the earphone case is connected to the earphone frame through a retractable connecting frame element having a mounting hardware for said retractable frame.

4. The hearing protector of claim 3, wherein the earphone further comprises a touch pad for placing on one cheek of a user, wherein the touch pad is on an opposite side of the earphone case and the touch pad is connected to the earphone frame through a second retractable connecting frame element having a second mounting hardware for said second retractable frame.

5. The hearing protector of claim 2, wherein the earphone case is connected with one component selected from the group consisting of an antenna, LCD screen, volume button, settings button, on/off button, aux in, function button, encoder, earmuffs, and retractable frame.

6. The hearing protector of claim 5, wherein the antenna is connected with a controller and an FM radio, and wherein the controller is connected with an AM/FM radio and Bluetooth through the encoder.

7. The hearing protector of claim 6, wherein an MP-3 audio player having a memory card slot and a USB port is connected with the controller through the encoder.

8. The hearing protector of claim 2, wherein the earphone case further comprises at least one circuit board and at least one speaker.

9. The hearing protector of claim 8, wherein the at least one circuit board comprises one component selected from the group consisting of an FM module, Bluetooth module, controller, and amplifier module.

10. The hearing protector of claim 9, wherein the earphone case further comprises a power module that is connected with one component selected from the group consisting of an LCD, AM/FM radio, Bluetooth, controller, and amplifier modules.

11. The hearing protector of claim 10, wherein the power module comprises a power inlet, battery, power indication and on/off button.

12. The hearing protector of claim 8, wherein the at least one speaker is enclosed in the earphone case.

13. The hearing protector of claim 2, wherein the earphone case further comprises a microphone.

14. The hearing protector of claim 1, wherein the rechargeable power unit is a rechargeable Lithium-ion battery.
